(19) United States
(12) Patent Application Publication
(10) Pub. No.: US 2014/0259835 A1
(43) Pub. Date: Sep. 18, 2014

(54) BEVERAGE CONTAINER INSULATOR WITH ENVELOPE FOR GRAPHIC DISPLAY

(71) Applicants: Christopher Leo Ptak, Plymouth, MI (US); Victor Alfred Ptak, Plymouth, MI (US)

(72) Inventors: Christopher Leo Ptak, Plymouth, MI (US); Victor Alfred Ptak, Plymouth, MI (US)

(21) Appl. No.: 14/213,821

(22) Filed: Mar. 14, 2014

Related U.S. Application Data
(60) Provisional application No. 61/785,886, filed on Mar. 14, 2013.

(51) Int. Cl. G09F 3/20

(52) U.S. Cl. CPC G09F 3/201
USPC 40/651

(57) ABSTRACT

An envelope is disclosed for attachment to a promotional good. The envelope encapsulates a display medium. The envelope includes a transparent top layer of plastic material through which the display medium can be visible and an initially open portal through which the display medium can be inserted. The open portal can be subsequently sealed.

### CROSS REFERENCE TO RELATED APPLICATIONS

This disclosure is claims the benefit of U.S. Provisional Application No. 61/785,886 filed on Mar. 14, 2013 which is hereby incorporated by reference.

### TECHNICAL FIELD

This disclosure is related to an object used to present a graphic display upon a distributed good. More specifically, the disclosure comprises a beverage container insulator to which is affixed a transparent envelope containing a display placard.

### BACKGROUND

The statements in this section merely provide background information related to the present disclosure. Accordingly, such statements are not intended to constitute an admission of prior art.

Promotional goods are used to provide a vehicle for a company or entity to distribute printed materials in a format that is likely to be kept and used by a target client, customer, or donor. A promotional good can be handed out, mailed, or otherwise distributed generally. A promotional good can be provided as part of an event or function, for example, provided to participants in a charity golf outing or a marathon dedicated to a particular cause.

A promotional good includes advertising or some graphical representation of the company, entity, or cause being promoted. Promotional goods can be customized to a particular company, for example, with text and/or graphics printed directly upon the good. However, such dedicated goods can be expensive and can require a long lead time to design and produce the goods. Advertising can be adhered or otherwise attached to a generic good. However, the advertising can be prone to contamination, water intrusion, abrasion to exposed printed materials, etc.

### BRIEF DESCRIPTION OF THE DRAWINGS

An envelope is disclosed for attachment to a promotional good. The envelope encapsulates a display medium. The envelope includes a transparent top layer of plastic material through which the display medium can be visible and an initially open portal through which the display medium can be inserted. The open portal can be subsequently sealed.

### BRIEF DESCRIPTION OF THE DRAWINGS

One or more embodiments will now be described, by way of example, with reference to the accompanying drawings, in which:

FIG. 1 illustrates a front view of the envelope containing the display placard affixed to a beverage container insulator, in accordance with the present disclosure;

FIG. 2 illustrates a reverse view of the envelope containing the display placard and a desiccant or absorbent material, in accordance with the present disclosure;

FIG. 3 illustrates a reverse view of an alternative embodiment of an envelope containing the display placard and a desiccant or absorbent material, in accordance with the present disclosure;

FIG. 4 illustrates an alternative embodiment of a promotional good using an envelope containing printed material, in accordance with the present disclosure;

FIG. 5 illustrates an alternative embodiment of a promotional good using an envelope containing printed material embodied as a baseball cap, in accordance with the present disclosure; and

FIG. 6 illustrates an alternative embodiment of a promotional good using an envelope containing printed material embodied as a wine bottle decorative cover, in accordance with the present disclosure.

### DETAILED DESCRIPTION

Referring now to the drawings, wherein the showings are for the purpose of illustrating certain exemplary embodiments only and not for the purpose of limiting the same, FIG. 1 illustrates a front view of an exemplary embodiment of a beverage container insulator 10, to which is affixed a transparent sealable envelope 11 containing an display medium embodied as a display placard 12. The beverage container insulator 10 may be made of foam polymer or any other similar material which can insulate a beverage container, and which can keep the user's hands free from condensation and other moisture. The transparent sealable envelope 11 may be made of plastic or a similar material, will be transparent on at least one side, and will be capable of being sealed on all sides. Envelopes can be made of multiple materials sealed together. Examplary, non-limiting materials include PVC, acetate, polypropylene, injected acrylic, ABS Plastic, and vinyl coated fabric (imitation leather.) Further, the transparent sealable envelope 11 will be of a size to contain within it a display placard 12, for example the size of a business card. The transparent sealable envelope 11 can be affixed, for example, permanently to the beverage container insulator so that the combination of 10 and 11 constitutes a single unit. Different pieces or materials can be sealed together according to any method known in the art, including but not limited to stitches/sewing, ultrasonic welding, heat seal welding, glue/adhesive, adhesive tape, rivets, zippers, magnets, snaps, buttons, and/or Velcro®. In one embodiment, envelope 11 can be part of or attached to a plastic shell that entirely surrounds the insulator. Alternatively, the transparent sealable envelope 11 may be affixed by the user to the beverage container insulator 10 by means of adhesive strips or in another similar manner. Envelope 11 includes an initially open portal providing an opening through which an display medium can be inserted. The open portal of the envelope can be subsequently sealed to protect the display medium inside. The seal can but need not be airtight—an airtight seal has an added benefit of preventing humid air, water, and other contaminants from getting within the envelope. The transparent sealable envelope 11 may be sealable, for example, by means of an installed adhesive. Alternatively, the transparent sealable envelope 11 may be sealable by using a heated sealing device or other similar device to close it. Display placard 12 is situated within transparent sealable envelope such that the printed words, logos, pictures or other information face away from the beverage container insulator 10 so that display placard 12 is clearly visible.

Envelope 11 can be constructed of two or more layers of plastic sheets. Top transparent layer 15 is illustrated Envelope 11 is illustrated including three permanently sealed edges 16 and one contemporaneously sealed edge 17, such that edge 17 can be initially open and later sealed once display placard 12 is inserted within envelope 11.

Insulator 10 can be constructed of any of a number of exemplary insulating materials known in the art, including but not limited to open cell polymer foam, for example, with a sealing layer applied to the foam, and, alternatively, closed cell polymer foam.

Promotional goods are frequently handed out at outdoor events. Such events can be in all kinds of weather. Such events can include hot, humid weather where any cold beverage, such as can be held by insulator 10, can create a significant amount of condensation. Methods to adhere or locate a business card or other printed material close to a beverage frequently result in the card getting wet and ruined, reducing the advertising value of the good. By sealing envelope 11, damage from water intrusion can be reduced. Similarly, if the good is distributed in a dusty or sandy environment, or if the good is distributed at an athletic event, the printed material contained within envelope 11 can be protected from dirt or other contamination.

In addition to or in the alternative to a business card or other printed material, a picture or a printed graphic can be protected within an envelope and affixed to a beverage insulator. For example, beverage insulators could be sized to keep bottles of wine cold, and envelopes affixed to the insulators could have pictures of an exemplary bride and groom, such that the wine bottles could be placed at tables at a wedding reception, with the pictures remaining intact and unharmed by condensation from the wine bottle, from drips of wine running down the bottle, or from other food or drink contamination from the table. Similar applications could include birthday parties, graduation parties, anniversary parties, retirement parties, etc. A number of beverage insulators such as wine insulators can be used in the alternative to the insulators illustrated herein, a number of printed or otherwise decorative materials could be included within the envelopes, and the disclosure is not intended to be limited to the examples provided herein.

FIG. 2 illustrates reverse view of the envelope of FIG. 1. Envelope 11 includes a rear layer 20 of plastic material. Layer 20 can be transparent or can be a colored layer of plastic. Envelope 11 includes opening 22 through which a business card or other material can be inserted. Lip 24 is provided to seal opening 22, for example by folding and adhering lip 24 to layer 20. Adhesive strip 23 is provided, for example, with a piece of removable waxy paper exposing adhesive, for sealing lip 24 to layer 20. An optional dessicant or absorbent strip 25 is provided, situated near opening 22 to prevent water from entering the opening. Strip 25 is illustrated on lip 24. Strip 25 can alternatively be situated inside opening 22, such that adhesive strip 23 can be more closely located to opening 22. Adhesive strips 21a and 21b are illustrated as an exemplary configuration to permit envelope 11 to be adhered to insulator 10, for example, long after the insulator has been made and sold to an advertising company. In one exemplary configuration, a box of blank insulators 10 could be matched with a box of empty envelopes 11, with business cards being installed to the envelopes and the envelopes being adhered to the insulators on demand. In another construction, envelope 11 can be adhered or permanently affixed to insulator 10 according to methods known in the art.

FIG. 3 illustrates a reverse view of an alternative embodiment of an envelope containing the display placard and a desiccant or absorbent material. Configuration 30 includes envelope 31 with display placard 12 installed thereto. Envelope 31 is illustrated, including a rear layer 33 of plastic. Rear layer 33 has been permanently affixed to a top layer of plastic along three edges 32. A fourth edge 34 includes lip 35 which has been folded over and thermally affixed to rear layer 33 through methods known in the art. Display placard 12 embodied as a business card is illustrated, with a back side of the card visible in FIG. 3. An exemplary desiccant or absorbent patch 38 is illustrated inserted behind display 12. Optional patch 38 is configured to absorb water and protect or extend the useful life of display 12, preventing water intrusion or condensation from soaking into display 12. Envelope 31 need not include lip 35, for example, wherein edge 34 can include sufficient material that a top layer of the envelope, including the transparent front of the envelope, can be directly affixed to rear layer 33. Sealing surface 36 is illustrated as an adhesive or glue material sealing lip 35 to rear layer 33.

Sealing surface 36 can take any of a number of sealing embodiments known in the art. Any glue, adhesive, or thermally formed barrier can be used. In another embodiment, a Ziploc® style barrier, a zipper connection, or a Velcro® seal can be used to seal initial open edge 34.

FIG. 4 illustrates an alternative embodiment of a promotional good using an envelope containing printed material embodied as a keychain. Configuration 40 includes keychain 41, the keychain being configured to accept envelope 44 configured to hold an display medium embodied as an advertising token 47. Display medium disclosed herein can be any shape or size. Keychain 41 includes key ring 43 and medallion 42. Envelope 44 is illustrated as a round packet, constructed of two layers of plastic material, with one half of the round shape sealed along top edge 45. A bottom edge 46 is open and ready to receive token 47. Token 47 includes a small round object configured to include print or an embossed message. Token 47 can be inserted into envelope 44, and bottom edge 46 can be sealed with adhesive, thermal bonding, or any method known in the art. Envelope 44 can be adhered, thermally bonded, or attached with any method known in the art to surface 48 of medallion 42. Such a keychain can be configured to release the token, for example, with a tear strip configured to envelope 44, such that the token can be redeemed for an advertised promotion.

Alternative embodiments of the display medium or token are envisioned. An embroidered patch or an injection molded badge could be inserted within an envelope for display upon a promotional good. A small electronic unit with a circuit board and either a small battery or a solar panel could be inserted, and the circuit board could provide any of a number of functions including lights, digital displays, sounds, location/global positioning devices, vibrating ringers, or gag schemes. Such display mediums could be fit within an envelope, attached to an outside of an envelope as disclosed herein, or attached directly to the promotional good, for example, with Velcro® strips.

FIG. 5 illustrates an alternative embodiment of a promotional good using an envelope containing printed material embodied as a baseball cap. Baseball cap 50 is illustrated including cap body 52 and cap bill 54. Cap body 52 includes reinforcement band 56 that is known in ball caps and reinforces the circumference of the cap body 52. Envelope 60 is illustrated positioned upon cap 50, such that a display placard 62 can be positioned within the envelope. Envelope 60 can be created with the cap 50, for example, with the stitching of the cap sealing to a perimeter of envelope 60. In another embodiment, envelope 60 can be affixed or attached to an existing ball cap, for example, with adhesive or rivets. Envelope 60, once receiving placard 62 through an initially open portal, can be permanently sealed, for example, with a thermal device being used to heat seal an edge of envelope 60. In another embodiment, an edge of envelope 60 can be provided with a tab that can be folded under or adhesively sealed. According to one embodiment, access to envelope 60 can be provided on an inside surface of the cap, such that the outside of the cap appears to be finished without any open or visibly altered edges. In one embodiment, access to envelope 60 can be provided by a flap that folds under reinforcement band 56. In one embodiment, envelope 60 can adhered to cap 50 with a removable adhesive, such that a promotional or event specific display can be provided within envelope 60, and when the event is over, the wearer can remove the envelope to keep the souvenir hat.

FIG. 6 illustrates an alternative embodiment of a promotional good using an envelope containing printed material embodied as a wine bottle decorative cover. Wine bottle assembly 70 is provided including wine bottle 72, wine bottle cover 74, and envelope 78 including display placard 76. In one embodiment, wine bottle 72 can include a Champagne or sparkling white wine, and display placard 76 can include a message related to an event such as a wedding or graduation. The wine bottle can be a promotional good as something placed at tables for a celebration with a message or advertisement for viewing by the people at the table. Wine bottle cover 74 can include an insulator within area 80 on the inside of the cover, for example, to keep a chilled bottle of wine cold. Wine bottle cover 74 can include an absorbent pad 82 near the neck of the bottle, for example, under a decorative surface of cover 74, to absorb any wine drips that come down the neck of bottle 72 after the wine is poured.

A number of additional promotional goods are envisioned that can be fitted with a sealed envelope including printed materials. An envelope can be a modular improvement to a promotional good, with a company or advertising agency making up improved goods on demand. Envelopes can be modularly improved, for example, with a promotion being decided upon at a last moment, enabled by rapid assembly of the display medium to the envelope and rapid attachment of the envelope to the promotional good. In another example, goods related to a sporting event can be quickly fashioned to fit a particular event with little warning of the particulars of the event. For example, the final contestants in a basketball tournament to fill the last eight, four, or two slots can be determined with only a few days notice. With the disclosed apparatus or device, promotional goods such as a hat can be provided showing particular game matchups with little notice, providing the supplier with competitive advantage over suppliers that need a week or more notice to supply promotional goods through other means.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus comprising an envelope encapsulating a display medium,
the envelope comprising:
a transparent top layer of plastic material through which the display medium can be visible; and
an initially open portal through which the display medium can be inserted;
wherein the open portal can be subsequently sealed; and
wherein the envelope is affixed to a promotional good.

2. The apparatus of claim 1, wherein the promotional good is a beverage container insulator.

3. The apparatus of claim 2, wherein the envelope is permanently affixed to the beverage container insulator.

4. The apparatus of claim 2, wherein the envelope is provided as a separate unit with adhesive to be affixed to the beverage container insulator.

5. The apparatus of claim 2, further comprising a desiccant pad inserted within the envelope behind the display medium, the desiccant pad being configured to absorb condensation within the envelope.

6. The apparatus of claim 1, wherein the promotional good is a wine bottle cover.

7. The apparatus of claim 6, wherein the display medium is a celebratory message for a wedding event.

8. The apparatus of claim 6, wherein the wine bottle cover includes an insulator.

9. The apparatus of claim 6, wherein the wine bottle cover includes an absorbent pad configured to absorb drips.

10. The apparatus of claim 1, wherein the promotional good is a keychain.

11. The apparatus of claim 1, wherein the promotional good is a baseball cap.

12. The apparatus of claim 11, wherein the envelope opens within an inside of the baseball cap.

13. The apparatus of claim 12, wherein the envelope includes opening flap that folds under a reinforcement band of the baseball cap.

14. The apparatus of claim 1, wherein the display medium comprises a business card.

15. The apparatus of claim 1, wherein the display medium comprises an event specific placard.

16. The apparatus of claim 15, wherein the envelope is removable; and wherein the promotional good is configured to be a souvenir once the envelope is removed.

17. The apparatus of claim 1, herein the display medium comprises a coupon providing an advertising incentive to the recipient of the promotional good.

18. The apparatus of claim 1, wherein the display medium comprises one of an embroidered patch, an injection molded badge, a battery-powered circuit board, and a solar-powered circuit board.

19. The apparatus of claim 1, wherein the open portal is sealed with one of glue, adhesive, a thermally formed barrier, a Ziploc® style barrier, a zipper connection, or a Velcro® seal.
